(19) United States
(12) Patent Application Publication
(10) Pub. No.: US 2015/0269690 A1
(43) Pub. Date: Sep. 24, 2015

(54) Methods and Systems for Facilitating a Subscription-Based On-Line Property Listing

(71) Applicant: Viva Group, LLC, Los Angeles, CA (US)

(72) Inventor: Robert N. Canning, Los Angeles, CA (US)

(21) Appl. No.: 14/610,664

(22) Filed: Jan. 30, 2015

Related U.S. Application Data
(63) Continuation of application No. 13/025,613, filed on Feb. 11, 2011.

(51) Int. Cl. G06Q 50/16; G06Q 20/12; G06Q 30/06

(52) U.S. Cl. CPC G06Q 50/16; G06Q 30/0601; G06Q 20/12

(57) ABSTRACT

Facilitating a subscription-based on-line property listing as part of an on-line property listing publication service are described. Consistent with some embodiments, in exchange for a fixed fee, a property listing is activated for a fixed duration of time, referred to as an activation period. At the end of the activation period, the property listing is deactivated if the property listing has generated a number of leads equal to or greater than some predetermined threshold number of leads. However, if the number of leads generated during the activation period was less than the threshold number, the property listing is reactivated for a rollover period.

### CROSS-REFERENCE TO RELATED APPLICATION

The present application claims priority to U.S. patent application Ser. No. 13/025,613, filed Feb. 11, 2011, and titled “Methods and Systems for Facilitating a Subscription-Based On-Line Property Listing,” the entire contents of which are incorporated herein by reference.

### TECHNICAL FIELD

The present disclosure generally relates to data processing techniques. More specifically, the present disclosure relates to methods and systems for facilitating a subscription-based on-line property listing as part of an on-line property listing publication service.

### BACKGROUND

A variety of on-line (e.g., Internet or web-based) services exist for persons who are looking to advertise the availability of a property (e.g., a home or apartment). A typical service offers a property manager the ability to provide information about an available property, which is then formatted as a property listing, and published for others to view for a certain length of time. In exchange for publicizing the availability of the property, the property manager typically pays a fixed fee that corresponds with the length of time the property listing is to be active (e.g., the activation period). This approach to property listings is problematic for a number of reasons. First, a property manager may be hesitant to pay a listing or posting fee to have the property listing active for a fixed duration if the property manager is not familiar with or does not trust the reliability and quality of the particular service. Additionally, requiring a property manager to pay a fixed fee to have a property listing activated for a fixed duration of time puts the burden on the property manager for determining the optimal timing for when the property listing should be active.

### DESCRIPTION OF THE DRAWINGS

Some embodiments are illustrated by way of example and not limitation in the figures of the accompanying drawings, in which:

FIG. 1 is a block diagram of some of the components and functional modules included in an Internet or web-based property listing publication service, consistent with some embodiments of the invention;

FIG. 2 is a flow diagram illustrating a method for managing a property listing, consistent with some embodiments of the invention;

FIGS. 3 and 4 are user interfaces showing an example of a property listing and a web-based form for submitting contact information, consistent with some embodiments of the invention; and

FIG. 5 is a block diagram of a machine in the form of a computer system within which a set of instructions, for causing the machine to perform any one or more of the methodologies discussed herein, may be executed.

### DETAILED DESCRIPTION

Methods and systems for facilitating a subscription-based on-line property listing as part of an on-line property listing publication service are described. In the following description, for purposes of explanation, numerous specific details are set forth in order to provide a thorough understanding of the various aspects of different embodiments of the present invention. It will be evident, however, to one skilled in the art, that the present invention may be practiced without these specific details.

For purposes of the present disclosure, an on-line or web-based property listing publication service (hereinafter, a publication service) is a computer-implemented virtual marketplace that brings together persons with an available property, and persons interested in the possibility of obtaining (e.g., buying, leasing or renting) an available property. Generally, such a service is facilitated over a data network with one or more computing devices, including servers, and client computing devices. A person looking to advertise the availability of a property provides information about the property, and then pays a fee in exchange for having a property listing generated and activated. When active, the property listing is viewable by others. In particular, the active property listing can be located via a search engine that allows persons interested in available properties to search for property listings based on various attributes of the properties, such as location, number of bedrooms, size, price, and so forth.

After a person identifies a property listing of interest via the publication service, the person can inquire about the property by contacting the property manager via contact information that is provided via the property listing, or by submitting contact information via a web-based form or email. To track the success of each property listing and to establish the number of sales leads that each property listing generates, the contact information that is provided via the property listing may allow for tracked or monitored communication with the property manager. For example, the contact information may be a special email address or telephone number that, when used by a person to inquire about a property, enables the operator of the publication service to confirm that a sales lead has been generated by the property listing. Alternatively, a property listing may have a web-based form, or a link to a web-based form, which allows a person interested in a property to submit his or her personal information to the property manager. Accordingly, for purposes of the present disclosure, the term “lead” or “sales lead” represents the first stage of a sales process, and is meant to encompass the situation when the identity of a person potentially interested in acquiring (e.g., buying, leasing or renting) an available property has been conveyed to a property manager, or a proxy or agent for the property manager. Consistent with some embodiments of the invention, a lead is determined to have been generated by a property listing when a person utilizes the contact information that is provided with an individual property listing to inquire about a property or otherwise identify himself to the property manager. For instance, with some embodiments, a lead is considered to have been generated each time a person emails or calls the property manager via the contact information provided in the property listing. In addition, a sates lead may be generated when a user submits information to a property manager via a web-based form. Of course, other lead tracking mechanisms may be utilized consistent with embodiments of the invention.

Consistent with some embodiments of the invention, in exchange for a fixed fee, a property manager's property listing is activated for a fixed duration of time referred to herein as the activation period (e.g., thirty days) during which time the property listing is viewable by others and the publication service monitors and tracks the number of leads that the property listing generates. When the activation period expires, if the property listing has generated some predetermined number of leads—for instance, some threshold number of leads then the property listing is simply deactivated. However, upon the expiration of the activation period, if the number of leads generated by the property listing is less than the threshold number of leads, the property listing is reactivated for an additional fixed duration of time reined to herein as a rollover period (e.g., an additional 30 days). During the rollover period, the publication service continues to monitor and track the leads generated by the property listing. If the number of leads generated by the property listing during the combined activation and rollover periods meets the threshold number of leads, then the property listing is deactivated. However, if the number of leads generated by the property listing does not meet the threshold number of leads, the property listing remains active during the entire duration of the rollover period, and upon expiration of the rollover period the property listing is deactivated. Other aspects of the inventive subject matter are explained in greater detail in connection with the description of the figures that follows.

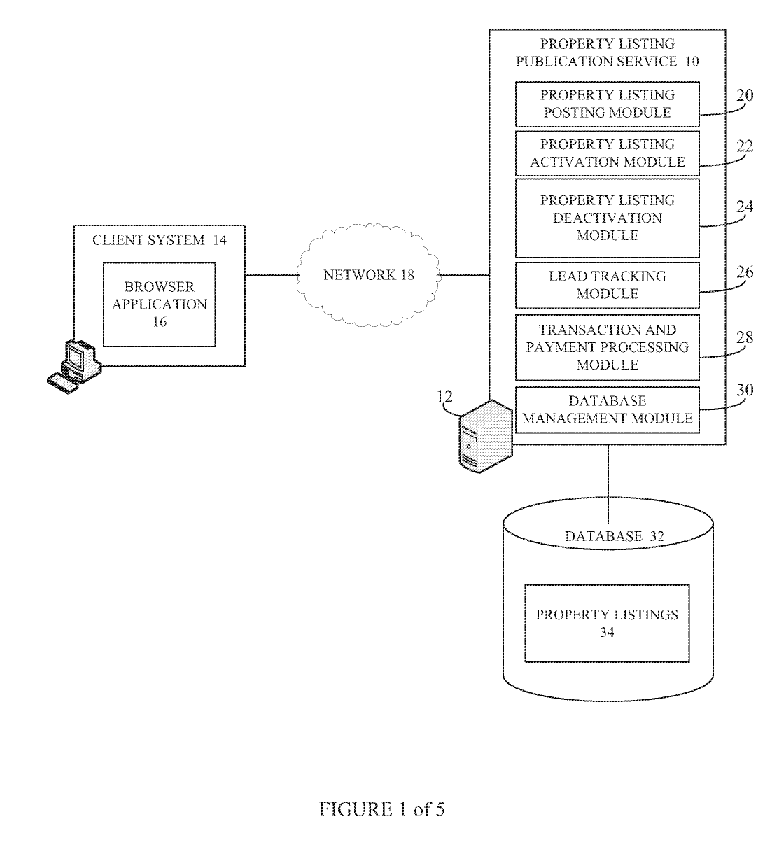

FIG. 1 is a block diagram of some of the components and functional modules included in an Internet or web-based property listing publication service 10, consistent with some embodiments of the invention. In general, the property listing publication service 10 executes on one or more servers 12, which can be accessed by one or more client devices or systems 14 (e.g., via a web browser client application 16) over a network 18. With some embodiments, the property listing publication service 10 may have or operate in connection with a web server, to serve web pages, or similar web-based content to one or more client applications, including web browser client applications.

As illustrated in FIG. 1, the property listing publication service 10 includes a property listing posting module 20. The property listing posting module 20 facilitates the submission, by property managers, of information concerning available properties. Such information, after being posted to the publication service 10, is used in the formation of property listings 30 that are ultimately published by the publication service 10, enabling users interested in properties to browse and search for the property listings. For instance, with some embodiments, the property listing posting module 20 operates in conjunction with a web server (not shown) to present users with one or more web-based forms, which prompt a user to provide information about a property. Once received, the information is stored in a database 32 managed by a database management module 30, and then presented in a property listing. Consistent with some embodiments, information concerning a particular property, or properties, may be stored by the publication service 10 for an extended period, such that a property manager need not re-enter the same information every time a property listing for a particular property is to be activated. With some embodiments, for instance, the publication service 10 provides a sort of “dashboard” or management portal through which a property manager can manage property listings for a portfolio of properties.

After a property manager has posted information concerning an available property and the publication service has generated a property listing for the property, or a property manager has selected a previously generated property listing, the user (e.g., property manager) will be presented with an option to activate one or more selected property listings. With some embodiments, the activation of a property listing will make the property listing viewable to others via the publication service 10, either by browsing or searching. In general, activation will be dependent upon paying a fixed fee. Accordingly, with some embodiments, a user interface or web page may be presented such that the web page includes one or more fields for the user to enter payment information to submit a payment for the activation fee. With some embodiments, the publication service may have an integrated transaction and payment processing module 28 for processing transactions and payments, while in other embodiments, the publication service may integrate with an external transaction and payment processing system.

As illustrated in FIG. 1, the publication service 10 includes a property listing activation module 22, which facilitates the activation of the property listing. For instance, with some embodiments, after processing a payment received from a user, the activation of the property listing is achieved, for example, by modifying a record in a database table to reflect the date and/or time at which the property listing is activated. This record can then be accessed to ensure that the property listing stays active for only a duration of time that is positively correlated with the amount of a fixed fee paid by the user. For instance, with some embodiments, several fee levels may exist and correspond with different activation periods for a property listing. In general, the greater the fee, the longer the property listing will be publicly accessible via the publication service. Of course, in some embodiments, a single fixed fee may be set for a single activation period.

As illustrated in FIG. 1, the property listing publication service 10 includes a property listing deactivation module 22. Accordingly, with some embodiments, the property listing deactivation module 22 facilitates the deactivation of the property listing upon the expiration of the activation period. In general, deactivating the property listing prevents the property listing from being viewable by the general public. However, consistent with some embodiments, a property listing may be extended for a predefined period of time referred to herein as a rollover period, if the property listing failed to generate a threshold number of sales leads during the activation period. For instance, if the threshold number of sales leads is five (5), and during the activation period (e.g., one month) the property listing failed to generate five (5) sales leads, the activation period of the property listing may be extended for a predefined rollover period, or until such time that the property listing generates a number of sales leads equal to the threshold number. Accordingly, with some embodiments, the deactivation module 22 monitors the number of sales leads that have been generated by a property listing, and compares the number of sales leads generated with a threshold number of sales leads associated with that property listing. With some embodiments, the threshold number of sales leads at which a property listing will be deactivated will be positively correlated with the amount of a fee paid by the property manager. For instance, a higher fee will generally correspond with a greater threshold number of sales leads available for the property listing—essentially guaranteeing that a property listing will generate a number of sates leads equal to the threshold number during the activation period, or be extended for at least one roll over period. With some embodiments, multiple rollover periods may be allowed, such that after the first rollover period, a second rollover period is allowed so long as the number of sales leads generated by the property listing has not yet reached the threshold number of sales leads for that property listing.

As illustrated in FIG. 1, the publication service includes a lead tracking module 26 for identifying when a sales lead has occurred, and for tracking the number of sales leads that each property listing has generated. The exact activity that constitutes a sates lead may vary from one embodiment to the next. For instance, with some embodiments, a sales lead is determined to have occurred when a user utilizes a predetermined phone number to make an inquiry about a particular property associated with a property listing. For instance, a user may be required to enter a sequence of numbers (e.g., via a telephone touch pad) to identify a property listing about which the user would like to inquire. When this occurs, the publication service 10 will determine that a sates lead has occurred for the particular property listing. Alternatively, or additionally, the lead tracking module 26 of the publication service 10 may determine that a sates lead has occurred when a user utilizes a particular email address to submit an inquiry about a particular property listing, or, when a user submits information via a web-based form. Of course, in other instances, the lead tracking module 26 may determine that a sales lead has occurred in other ways.

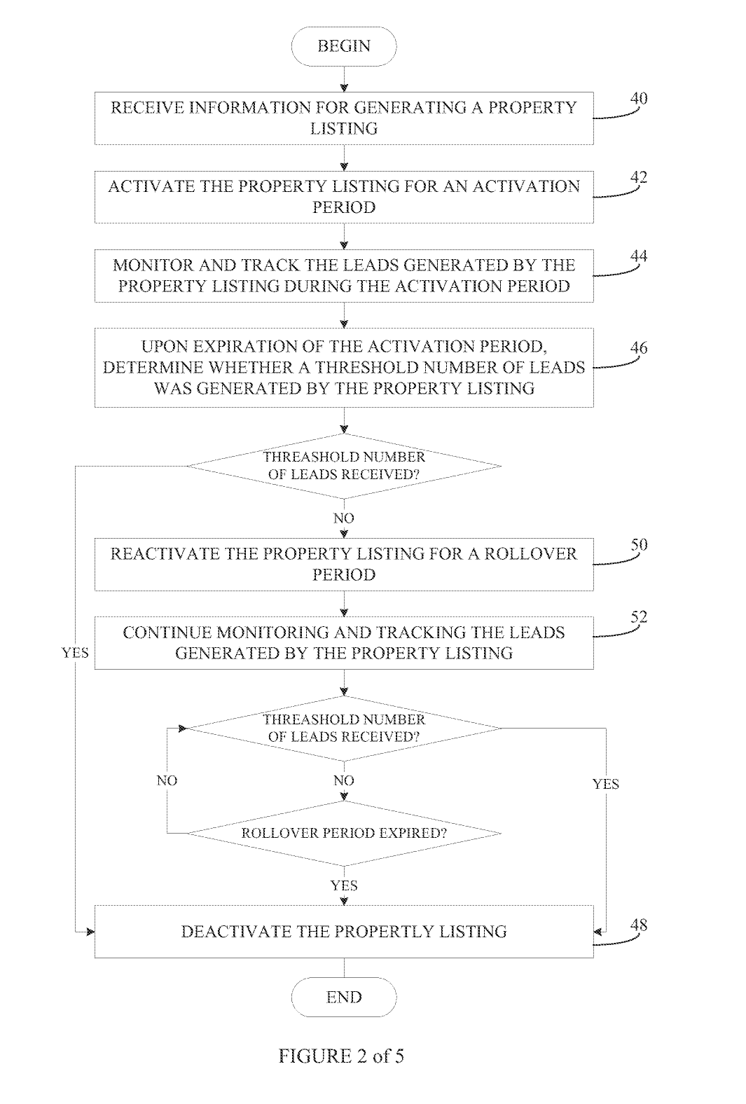

FIG. 2 is a flow diagram illustrating a method for managing a property listing, consistent with some embodiments of the invention. As illustrated in the flow diagram of FIG. 2, the method begins at method operation 40, when the publication service receives from a computing device of the property manager some information associated with a property for which a property listing is to be generated. For instance, such information may be communicated to the publication service by having the property manager select items of information from various drop-down lists, and provide information via web-based forms, and so forth. At method operation 42, the property listing is activated, making it publicly accessible via browsing and searching, for a predefined period of time known as the activation period. For example, with some embodiments, the property listing is activated in exchange for the payment of a fee. Accordingly, a transaction and payment processing module may process the payment of a fee, and then notify a property listing activation module, which in turn, activates the property listing by manipulating data in database table to reflect that active status of the property listing.

At method operation 44, the publications service (e.g., the lead tracking module 26) monitors and tracks the sales leads that are generated by the property listing. For instance, as the property listing is displayed to users in a search results page, or as a result of a user browsing for properties having certain attributes, the property listing will be displayed, and sales leads may be generated. With some embodiments, a sates lead is determined to have occurred when one of several activities occurs. For instance, with some embodiments, a sales lead is determined to have occurred when a user utilizes a special phone number to make an inquiry about a property associated with a property listing. In some embodiments, a sales lead is determined to have occurred when a user utilizes a special email associated with a property listing. In yet other embodiments, a sales lead may be determined to occur when a web-based form is submitted with information about the person making the inquiry about the property associated with the property listing. In other embodiments, other mechanisms may be utilized for determining and tracking the occurrence of sales leads.

At method operation 46, upon the expiration of the activation period, the publication service determines whether the property listing generated a predetermined threshold number of sales leads during the activation period. If, during the activation period, the property listing generated a number of sales leads equal to or greater than (or, simply greater than) the threshold number of sates leads, then at method operation 48, the property listing is deactivated, preventing it from being viewed by the public. However, if the property listing has not generated a number of sales leads equal to or greater than (or, simply greater than) the predetermined threshold number of sales leads, then at method operation 50 the property listing is extended or re-activated for a rollover period. During the rollover period (e.g., at method operation 52), the number of sales leads is continually tracked and monitored until the first of two events occurs. For instance, if at method operation 54, a determination is made that the combined number of sales leads generated by the property listing during the activation period and the rollover period is equal to, or greater than a predetermined threshold number, then the property listing is deactivated. However, if at method operation 56, a determination is made that the rollover period has ended without the property listing generating the predetermined threshold number of sales leads, then the property listing is deactivated. In some embodiments, multiple rollover periods may be used, such that the active period of the property listing may be extended multiple times until the threshold number of sales leads is generated.

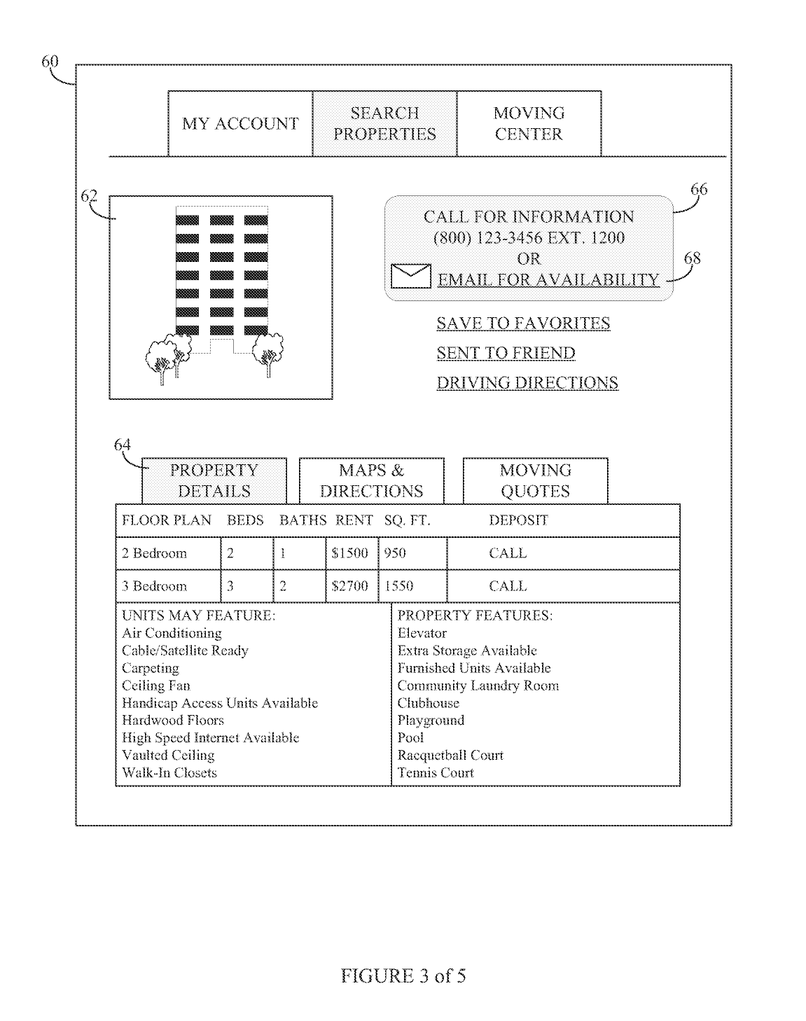

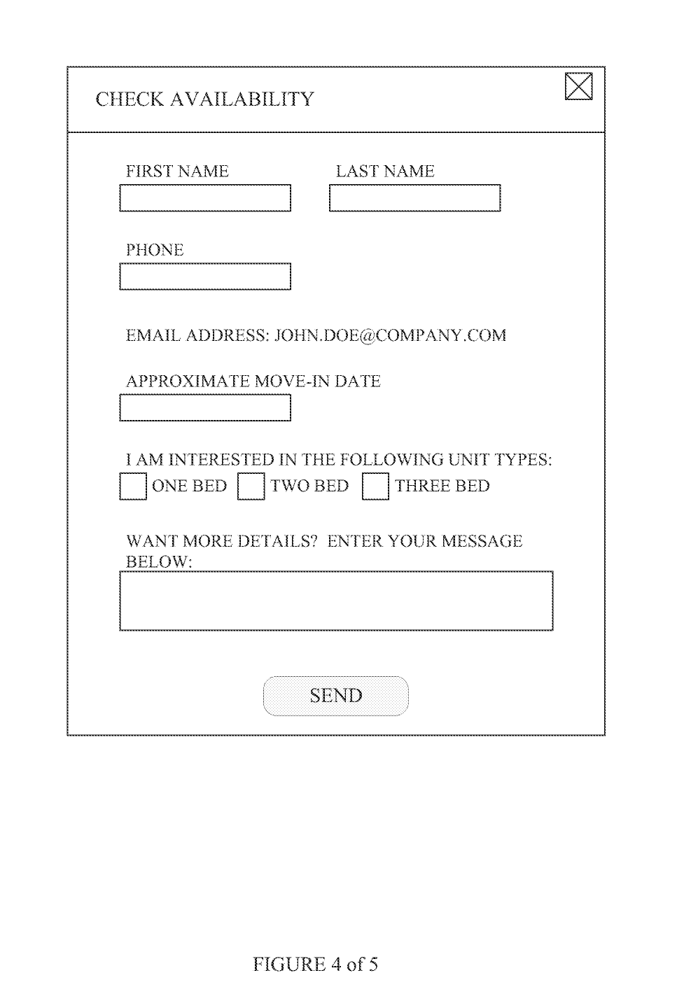

FIGS. 3 and 4 are user interfaces showing an example of a property listing with a web-based form for submitting an inquiry that is determined to be a sales lead, consistent with some embodiments of the invention. As illustrated in FIG. 3, the property listing 60 includes a picture of the property 62, as well as description of the property's various characteristics or attributes 64. By selecting any one of several different tabs, different information about the property may be selected for display. In addition to the picture and the property information, a telephone number and an email address are displayed together in a text box 66. By dialing the displayed phone number, a sales lead may be generated. Alternatively, a user may select the link 68 to send an email, via a web-based form, with an inquiry about the property associated with the property listing. When the link is selected, the user interface in FIG. 4 may be displayed or presented to the user. By providing the information requested in the web-based form, and then selecting the “SEND” button, the user can submit an inquiry about the property, where the inquiry is considered to be a sales lead for the property listing.

The various operations of example methods described herein may be performed, at least partially, by one or more processors that are temporarily configured (e.g., by software) or permanently configured to perform the relevant operations. Whether temporarily or permanently configured, such processors may constitute processor-implemented modules that operate to perform one or more operations or functions. The modules referred to herein may, in some example embodiments, comprise processor-implemented modules.

Similarly, the methods described herein may be at least partially processor-implemented. For example, at least some of the operations of a method may be performed by one or more processors or processor-implemented modules. The performance of certain of the operations may be distributed among the one or more processors, not only residing within a single machine, but deployed across a number of machines. In some example embodiments, the processor or processors may be located in a single location (e.g., within a home environment, an office environment or as a server farm), while in other embodiments the processors may be distributed across a number of locations.

The one or more processors may also operate to support performance of the relevant operations in a “cloud computing” environment or as a “software as a service” (SaaS). For example, at least some of the operations may be performed by a group of computers (as examples of machines including processors), these operations being accessible via a network (e.g., the Internet) and via one or more appropriate interfaces (e.g., Application Program Interfaces (APIs).)

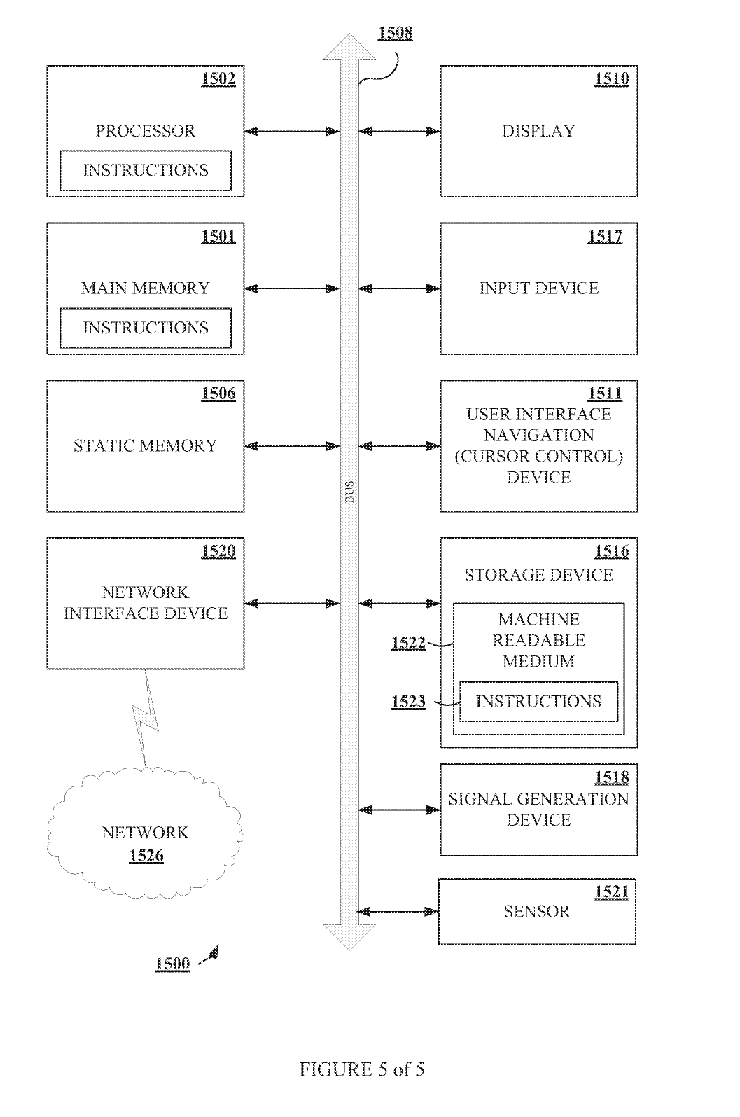

FIG. 5 is a block diagram of a machine in the form of a mobile device within which a set of instructions, for causing the machine to perform any one or more of the methodologies discussed herein, may be executed. In alternative embodiments, the machine operates as a standalone device or may be connected (e.g., networked) to other machines. In a networked deployment, the machine may operate in the capacity of a server or a client machine in server-client network environments, or as a peer machine in peer-to-peer (or distributed) network environments. The machine may be a personal computer (PC), a tablet PC, a set-top box (STB), a Personal Digital Assistant (PDA), a mobile telephone, a web appliance, a network router, switch or bridge, or any machine capable of executing instructions (sequential or otherwise) that specify actions to be taken by that machine. Further, while only a single machine is illustrated, the term “machine” shall also be taken to include any collection of machines that individually or jointly execute a set (or multiple sets) of instructions to perform any one or more of the methodologies discussed herein.

The example computer system 1500 includes a processor 1502 (e.g., a central processing unit (CPU), a graphics processing unit (CPU) or both), a main memory 1501 and a static memory 1506, which communicate with each other via a bus 1508. The computer system 1500 may further include a display unit 1510, an alphanumeric input device 1517 (e.g., a keyboard), and a user interface (UI) navigation device 1511 (e.g., a mouse). In one embodiment, the display, input device and cursor control device are a touch screen display. The computer system 1500 may additionally include a storage device (e.g., drive unit 1516), a signal generation device 1518 (e.g., a speaker), a network interface &vice 1520, and one or more sensors 1521, such as a global positioning system sensor, compass, accelerometer, or other sensor.

The drive unit 1516 includes a machine-readable medium 1522 on which is stored one or more sets of instructions and data structures (e.g., software 1523) embodying or utilized by any one or more of the methodologies or functions described herein. The software 1523 may also reside, completely or at least partially, within the main memory 1501 and/or within the processor 1502 during execution thereof by the computer system 1500, the main memory 1501 and the processor 1502 also constituting machine-readable media.

While the machine-readable medium 1522 is illustrated in an example embodiment to be a single medium, the term “machine-readable medium” may include a single medium or multiple media (e.g., a centralized or distributed database, and/or associated caches and servers) that store the one or more instructions. The term “machine-readable medium” shall also be taken to include any tangible medium that is capable of storing, encoding or carrying instructions for execution by the machine and that cause the machine to perform any one or more of the methodologies of the present invention, or that is capable of storing, encoding or carrying data structures utilized by or associated with such instructions. The term “machine-readable medium” shall accordingly be taken to include, but not be limited to, solid-state memories, and optical and magnetic media. Specific examples of machine-readable media include non-volatile memory, including by way of example semiconductor memory devices, e.g., EPROM, EEPROM, and flash memory devices; magnetic disks such as internal hard disks and removable disks; magneto-optical disks; and CD-ROM and DVD-ROM disks.

The software 1523 may further be transmitted or received over a communications network 1526 using a transmission medium via the network interface device 1520 utilizing any one of a number of well-known transfer protocols (e.g., HTTP). Examples of communication networks include a local area network (“LAN”), a wide area network (“WAN”), the Internet, mobile telephone networks, Plain Old Telephone (POTS) networks, and wireless data networks (e.g., Wi-Fi.® and WiMax® networks). The term “transmission medium” shall be taken to include any intangible medium that is capable of storing, encoding or carrying instructions for execution by the machine, and includes digital or analog communications signals or other intangible medium to facilitate communication of such software.

Although an embodiment has been described with reference to specific example embodiments, it will be evident that various modifications and changes may be made to these embodiments without departing from the broader spirit and scope of the invention. Accordingly, the specification and drawings are to be regarded in an illustrative rather than a restrictive sense. The accompanying drawings that form a part hereof, show by way of illustration, and not of limitation, specific embodiments in which the subject matter may be practiced. The embodiments illustrated are described in sufficient detail to enable those skilled in the art to practice the teachings disclosed herein. Other embodiments may be utilized and derived therefrom, such that structural and logical substitutions and changes may be made without departing from the scope of this disclosure. This Detailed Description, therefore, is not to be taken in a limiting sense, and the scope of various embodiments is defined only by the appended claims, along with the full range of equivalents to which such claims are entitled.

1. A system comprising:
a computer network; and
a property listing server computer that is communicatively coupled to one or more client computers, wherein the property listing publication server computer is configured to:
prompt a user to receive information pertaining to an available property;
generate a property listing with the information pertaining to the available property, the property listing including contact information for use in inquiring about a property described in the property listing;
after generating the property listing and prior to an activating the property listing,
provide an option to activate the property listing by presenting a user-interface comprising one or more fields to enter payment information to submit a payment for the activation fee;
receive and process the payment associated with the activation fee;
responsive to receiving and processing the payment associated with the activation fee, modify a record associated with the property listing to reflect the date and time at which the property listing is activated;
responsive to modifying the record, activate the property listing for an activation period by making the property listing viewable to others via a searchable property listing publication service during the activation period;
identify a communication that uses the contact information;
determine that the communication is associated with an inquiry about the property described in the property listing;
responsive to identifying the communication is associated with the inquiry about the property, qualify the communication as a sales lead associated with the property described in the property listing;
track a number of sales leads generated by the property listing during the activation period;
upon expiration of the activation period and responsive to determining that the number of leads generated by the property listing is less than a threshold number of leads, extend the activation of the property listing for a rollover period;
responsive to extending the activation of the property listing for the rollover period, determine that the number of leads generated by the property listing during a time period corresponding to the combination of the activation period and the rollover period meets the threshold number of leads;
responsive to a determination that the number of leads generated by the property listing during the time period corresponding to the combination of the activation period and the rollover period meets the threshold number of leads, deactivate the property listing prior to the expiration of the rollover period; and
responsive to a determination that the number of leads generated by the property listing during the time period corresponding to the combination of the activation period and the rollover period fails to meets the threshold number of leads, deactivate the property listing upon expiration of the rollover period.

2. The system of claim 1, wherein the contact information includes at least one of a phone number and an electronic mail address.

3. The system of claim 1, wherein the duration of time represented by the activation period is dependent upon an amount of the activation fee paid in exchange for activating the property listing.

4. The system of claim 1, wherein the threshold number of leads is dependent upon and positively correlated with the amount of the activation fee paid to activate the property listing.

5. A method comprising:
prompting, by a property listing server computer, for receiving information pertaining to an available property;
generating, by the property listing server computer, a property listing with the information pertaining to the available property, the property listing including a phone number and an electronic mail address for use in inquiring about a property described in the property listing;
after generating the property listing and prior to activating the property listing,
providing, by a property listing server computer, an option to activate the property listing by presenting a user-interface comprising one or more fields to enter payment information to submit a payment for the activation fee;
receiving and processing the payment associated with the activation fee;
in exchange to receiving and processing the payment associated with the activation fee, activating the property listing for an activation period by making the property listing viewable to others via a searchable property listing publication service during the activation period;
identifying a communication using at least one of the phone number and the electronic mail address;
determining that the communication is associated with an inquiry about the property described in the property listing;
responsive to identifying that the communication is associated with the inquiry about the property, qualifying the communication as a sales lead associated with the property described in the property listing;
tracking a number of leads generated by the property listing during the activation period; and
upon expiration of the activation period, responsive to determining that the number of leads generated by the property listing is equal to or greater than a threshold number of leads, deactivating the property listing.

6. The method of claim 5, wherein generating a property listing with information pertaining to an available property includes storing the received information in a database.

7. The method of claim 5, wherein activating the property listing for an activation period by making the property listing viewable to others via a searchable property listing publication service during the activation period includes modifying a record associated with the property listing to reflect the date and time at which the property listing is activated.

8. One or more servers operating a property listing publication service, comprising:
a property listing posting processor to prompt for and receive information pertaining to an available property and to generate a property listing with the received information, the property listing including contact information for use in inquiring about a property described in the property listing;
after generating the property listing and prior to activating the property listing,
a property activation processor to provide an option to activate the property listing by presenting a user-interface comprising one or more fields to enter payment information to submit a payment for the activation fee;
a transaction and payment processing processor to receive and process a payment associated with the activation fee;
a property listing activation processor to modify a record associated with the property listing to reflect the date and time at which the property listing is activated, and activate, in exchange to receiving and processing the payment associated with the activation fee, the property listing for an activation period by making the property listing viewable to others via a searchable property listing publication service during the activation period;
a lead tracking processor to:
track a number of leads generated by the property listing during the activation period, wherein the property listing activation processor is to extend the activation of the property listing for a rollover period at the expiration of the activation period when the lead tracking module determines that the number of leads generated by the property listing during the activation period is less than a threshold number of leads, and
track, during the rollover period, the number of leads generated by the property listing during a time period corresponding to a combination of the activation period and the rollover period,
wherein to track the number of leads, the lead tracking processor is configured to:
identify a communication that uses the contact information;
determine that the communication is associated with an inquiry about the property described in the property listing;
responsive to identifying the communication is associated with the inquiry about the property, qualify the communication as a sales lead associated with the property described in the property listing; and
a property listing deactivation processor configured to:
deactivate the property listing prior to the expiration of the rollover period in response to a determination by the lead tracking module that the combined number of leads generated over the time period corresponding to the combination of the activation period and the rollover period equals a threshold number of leads, and
deactivate the property listing upon expiration of the rollover period in response to a determination by the lead tracking module that the number of leads generated by the property listing during the time period corresponding to the combination of the activation period and the rollover period fails to meets the threshold number of leads.

9. The one or more servers of claim 8, wherein the contact information includes at least one of a phone number, an electronic mail address, and a web based form.

10. The one or more servers of claim 8, wherein the duration of time represented by the activation period is dependent upon an amount of the activation fee paid in exchange for activating the property listing.
